(19) United States
(12) Patent Application Publication
(10) Pub. No.: US 2025/0244493 A1
(43) Pub. Date: Jul. 31, 2025

(54) METHODS AND APPARATUS FOR ESTIMATING SEISMIC DEPTH UNCERTAINTY

(71) Applicant: BP Corporation North America Inc., Houston, TX (US)

(72) Inventors: Alistair Crosby, London (GB); Eric Kazlauskas, Houston, TX (US)

(73) Assignee: BP Corporation North America Inc., Houston, TX (US)

(21) Appl. No.: 19/041,352

(22) Filed: Jan. 30, 2025

Related U.S. Application Data
(60) Provisional application No. 63/627,163, filed on Jan. 31, 2024.

(51) Int. Cl. G01V 1/28; G01V 1/30

(52) U.S. Cl. CPC G01V 1/282; G01V 1/305; G01V 2210/514; G01V 2210/614

(57) ABSTRACT

A method for estimating uncertainty in seismic-derived depth prognoses of a subsurface region includes receiving an initial velocity model of a subsurface region based on seismic data associated with the subsurface region, performing a seismic de-migration on initial post-migration seismic data obtained from the initial velocity model to obtain pre-migration seismic data, and perturbing one or more of the components of the initial velocity model to produce a plurality of perturbed velocity models that are each different from the initial velocity model. The method further includes performing a seismic migration of the pre-migration seismic data using the perturbed velocity model to obtain perturbed post-migration seismic data for each of the plurality of perturbed velocity models, estimating a depth error from a depth prognosis obtained from a selected subset of the perturbed velocity models based on characteristics of the perturbed post-migration seismic data, and estimating a depth uncertainty from the estimated depth error.

### CROSS-REFERENCE TO RELATED APPLICATIONS

This application claims benefit of U.S. provisional patent application Ser. No. 63/627,163 filed Jan. 31, 2024, and entitled “Methods and Apparatus for Estimating Seismic Depth Uncertainty,” which is hereby incorporated herein by reference in its entirety for all purposes.

### STATEMENT REGARDING FEDERALLY SPONSORED RESEARCH OR DEVELOPMENT

Not applicable.

### BACKGROUND

Seismic surveying is a method of exploration geophysics in which seismology is used to estimate properties of earthen subsurface regions from reflected seismic waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off the interface and is recorded at the surface as seismic data associated with the subsurface region, while some of the wave energy refracts through the interface and penetrates deeper into the subsurface region. The reflected wave energy recorded at the surface as seismic data may be studied to ascertain information about the subsurface region. For example, the recorded seismic data may be used to construct a velocity model of the subsurface region. In general, a velocity model models the velocity of the seismic waves passing through the subsurface region so as to translate subsurface reflection points of the seismic waves to their true depth within the formation.

### BRIEF SUMMARY OF THE DISCLOSURE

Methods and apparatus for estimating seismic depth uncertainty are disclosed herein. In an embodiment, a method for estimating uncertainty in seismic-derived depth prognoses of a subsurface region comprises (a) receiving an initial velocity model of a subsurface region based on seismic data associated with the subsurface region and captured by one or more seismic receivers, (b) performing a seismic de-migration on initial post-migration seismic data obtained from the initial velocity model to obtain pre-migration seismic data, (c) perturbing one or more components of the initial velocity model to produce a plurality of perturbed velocity models that are each different from the initial velocity model, (d) performing a seismic migration of the pre-migration seismic data using the perturbed velocity model to obtain perturbed post-migration seismic data for each of the plurality of perturbed velocity models, (e) estimating a depth error from a depth prognosis obtained from a selected subset of the perturbed velocity models based on characteristics of the perturbed post-migration seismic data migrated using the perturbed velocity models, and (f) estimating a depth uncertainty from the estimated depth error. In some embodiments, the pre-migration seismic data comprises one or more seismic gathers. In some embodiments, the one or more seismic gathers comprise common image point seismic gathers. In some embodiments, (b) further comprises generating a travel-time table from the initial velocity model using a vertically transverse isotropic (VTI) anisotropic processing model prior to performing the seismic de-migration. In certain embodiments, the seismic data comprises synthetic seismic gathers initially defined in a depth domain independent of the travel-time table. In some embodiments, (d) comprises migrating one or more time-domain synthetic seismic gathers to the depth domain to obtain perturbed synthetic seismic gathers that comprise the perturbed post-migration seismic data. In some embodiments, (f) comprises applying a predefined criterion to the plurality of perturbed velocity models to divide the plurality of perturbed velocity models between an acceptable group of perturbed velocity models used in estimating the depth uncertainty and an unacceptable group of perturbed velocity models not used in estimating the depth uncertainty. In some embodiments, (f) comprises generating a distribution of the depth prognoses, and using a predefined percentile of the distribution of the depth prognoses to define the estimated depth uncertainty. In some embodiments, the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.

In an embodiment, a method for estimating uncertainty in seismic-derived depth prognoses of a subsurface region comprises (a) receiving an initial velocity model of a subsurface region based on seismic data associated with the subsurface region and captured by one or more seismic receivers, (b) performing a seismic de-migration on initial post-migration seismic data obtained from the initial velocity model to obtain pre-migration seismic data, wherein the initial post-migration seismic data comprises a plurality of initial seismic gathers obtained from the seismic data, (c) perturbing the initial velocity model to produce a plurality of perturbed velocity models that are each different from the initial velocity model, (d) performing a seismic migration of the pre-migration seismic data using the perturbed velocity model to obtain perturbed post-migration seismic data for each of the plurality of perturbed velocity models, wherein the perturbed post-migration seismic data comprises a perturbed seismic gather, (e) determining a semblance for the perturbed seismic gather for each of the plurality of perturbed velocity models, (f) selecting a subset of the plurality of perturbed velocity models by applying a predefined semblance criterion to the perturbed semblances to obtain one or more selected velocity models, (g) estimating a depth error from a depth prognosis obtained from the one or more selected velocity models, and (h) estimating a depth uncertainty from the estimated depth error. In some embodiments, the initial post-migration seismic data comprises one or more seismic gathers obtained from the seismic data. In certain embodiments, the one or more seismic gathers comprise common image point gathers. In some embodiments, the perturbed post-migration data comprises one or more perturbed seismic gathers and the perturbed semblance is obtained from the one or more perturbed seismic gathers. In some embodiments, (f) comprises dividing the plurality of velocity models between an acceptable group of perturbed velocity models used in estimating the depth uncertainty, and an unacceptable group of perturbed velocity models not used in estimating the depth uncertainty. In some embodiments, (h) comprises determining a distribution of the depth prognoses, and taking a predefined percentile of the distribution of the depth prognoses to define the estimated depth uncertainty. In some embodiments, the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.

In an embodiment, a system for estimating uncertainty of a seismic-derived depth prognoses of a subsurface region comprises a processor, a non-transitory memory, and an application stored in the non-transitory memory that, when executed by the processor: receives an initial velocity model of a subsurface region based on seismic data associated with the subsurface region and captured by one or more seismic receivers, performs a seismic de-migration on initial post-migration seismic data obtained from the initial velocity model to obtain pre-migration seismic data, perturbs one or more components of the initial velocity model to produce a plurality of perturbed velocity models that are each different from the initial velocity model, performs a seismic migration of the pre-migration seismic data using the perturbed velocity model to obtain perturbed post-migration seismic data for each of the plurality of perturbed velocity models, estimates a depth error from a depth prognosis obtained from a selected subset of the perturbed velocity models based on characteristics of the perturbed post-migration seismic data migrated using the perturbed velocity models, and estimates a depth uncertainty from the estimated depth errors. In some embodiments, the application, when executed by the processor, generates a distribution of the depth prognoses, and uses a predefined percentile of the distribution of the depth prognoses to define the estimated depth uncertainty. In some embodiments, the application when executed by the processor: applies a predefined criterion to the plurality of perturbed velocity models to divide the plurality of perturbed velocity models between an acceptable group of perturbed velocity models used in estimating the depth uncertainty and an unacceptable group of perturbed velocity models not used in estimating the depth uncertainty. In some embodiments, the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.

### BRIEF DESCRIPTION OF THE DRAWINGS

For a detailed description of various exemplary embodiments, reference will now be made to the accompanying drawings in which:

FIGS. 1 and 2 illustrate exemplary seismic gathers in accordance with principles described herein;

FIG. 3 is a schematic view of an embodiment of a system for performing a marine seismic survey in accordance with principles described herein;

FIG. 4 is a schematic view of an embodiment of a system for performing a land-based seismic survey in accordance with principles described herein;

FIG. 5 is a block diagram of an embodiment of a computer system in accordance with principles described herein;

FIG. 6 is a flowchart illustrating an embodiment of a method for estimating uncertainty in seismic-derived depth prognoses of a subsurface region in accordance with principles described herein;

FIG. 7 is an exemplary velocity profile graph in accordance with principles described herein;

FIG. 8 is an exemplary anisotropy profile graph in accordance with principles described herein;

FIG. 9 is an exemplary stack bandwidth graph in accordance with principles described herein;

FIG. 10 illustrates an exemplary synthetic seismic gather in accordance with principles described herein;

FIG. 11 illustrates an exemplary baseline seismic gather in accordance with principles described herein;

FIG. 12 illustrates an exemplary perturbed seismic gather in accordance with principles described herein;

FIG. 13 is an exemplary moveout detectability graph in accordance with principles

described herein;

FIG. 14 is a flowchart illustrating another embodiment of a method for estimating uncertainty in seismic-derived depth prognoses of a subsurface region in accordance with principles described herein;

FIG. 15 is a diagram of exemplary perturbed seismic gathers in accordance with principles described herein ranked according to their respective flatness; and

FIGS. 16 and 17 are exemplary depth uncertainty maps in accordance with principles described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, seismic surveys reflect seismic waves off of features of earthen subsurface regions in order to collect information regarding the subsurface regions. The information collected from the reflected seismic waves may be used to create velocity models and seismic images which may be used to identify subterranean features of interest such as, for example, hydrocarbon deposits. As an example, in some applications an iterative data-fitting process such as a full waveform inversion (FWI) process may be applied to the collected seismic data to form a velocity model therefrom. Typically, FWI processes for generating velocity models of subsurface regions includes comparing synthetic seismic information generated by an initial estimate of the velocity model with the collected seismic data to iteratively minimize an objective cost function.

The computed velocity model may be used to image structures located within a subsurface region using a variety of techniques including, for example, prestack depth migration (PSDM) techniques. The quality of seismic images of a subsurface region produced from a velocity model is contingent on the accuracy of the velocity model from which the seismic images are produced. A continuing problem in the field of seismic imaging of subsurface regions is the determination of uncertainty of the depths of subsurface features of interest (referred to generally herein as “depth uncertainty”) as estimated by a velocity model and from which seismic images and other seismic products are produced. Such depth uncertainty is a significant contributor to error in estimating the volume of features of interest (e.g., subsurface hydrocarbon deposits) especially in areas of limited well control. Additionally, depth uncertainty presents an operational risk in well planning, impacting geologic prognoses, pore pressure estimation, casing points, and well true depth (TD).

Conventional methods for estimating depth uncertainty are limited. For example, conventionally, it is common practice to estimate depth uncertainty by comparing estimated depth (e.g., as estimated by a velocity model) of features of a subsurface region with control points in the form of data obtained from a well penetrating the subsurface region as part of a well-tie-based uncertainty analysis. However, control points can only be applied at a limited number of discretely separate depths where there is clear correspondence with the obtained seismic data such that a comparison can be drawn between the well and seismic data, limiting the potential of well data in estimating depth uncertainty. The accuracy of well-tie-based uncertainty analysis rapidly diminishes with increasing distance from the control points. Eventually, direct correction becomes impossible, and the uncertainty must instead be estimated solely from the seismic data. Due to these limitations, estimated depth for a given subsurface region generally amounts to a best guess at the TD of the given feature of interest that does not include the uncertainty of the estimate.

Conceptually, seismic depth uncertainty may be considered the sum of three separate components: reducible velocity-related depth uncertainty, irreducible velocity-related depth uncertainty, and interpretation-related uncertainty. Reducible velocity-related depth uncertainty results from errors in seismic velocity estimation, and can be diagnosed by a lack of flatness in common image point (CIP) seismic gathers produced by a velocity model. As used herein, the term “seismic gather” refers to a collection of seismic traces (e.g., obtained by migration of data recorded from seismic nodes or receivers such as hydrophones and the like) that share a common geometric attribute. For example, some seismic gathers comprise common depth point (CDP) gathers sharing the common attribute of a common depth point.

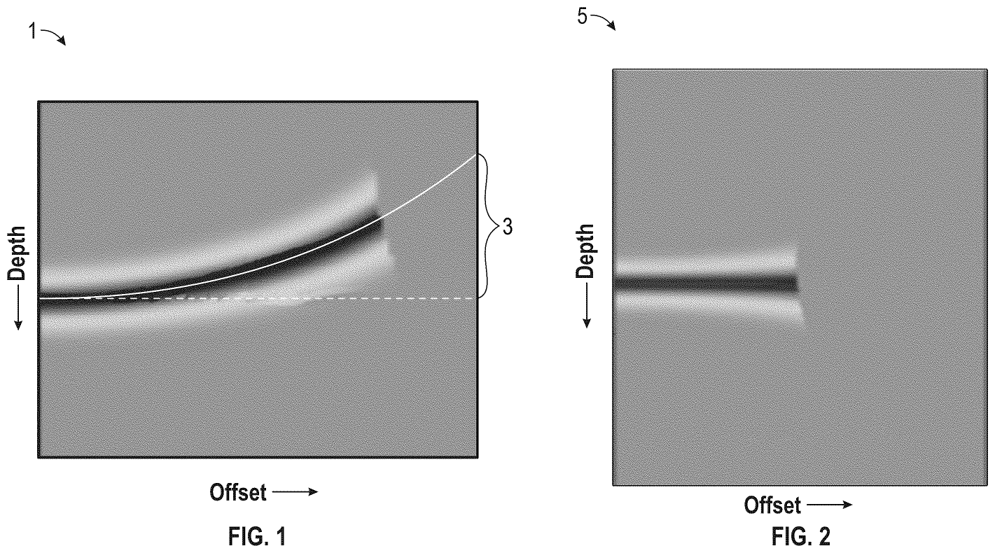

Referring now to FIG. 1, an exemplary seismic gather 1 (e.g., a CIP seismic gather) produced by migrating seismic data with a velocity model is shown illustrating an example of reducible velocity-related depth uncertainty 3. The Y-axis of seismic gather 1 corresponds to increasing depth while the X-axis of seismic gather 1 corresponds to increasing offset. Particularly, the reducible depth uncertainty 3 in the velocity model that produced seismic gather 1 is reflected in the degree of “residual moveout” or curvature of the seismic gather 1 along the X-axis thereof (e.g., curvature following increasing offset distance). The reducible depth uncertainty 3 may thus be observed directly from the seismic gather 1 given that reducible depth uncertainty 3 is associated with the degree of curvature of the seismic gather 1 along the X-axis thereof.

Conversely, irreducible depth uncertainty represents the null space of velocity models with different depth prognoses that are nevertheless consistent with flat seismic gathers for some particular acquisition and subsurface geology. Referring to FIG. 2, an exemplary seismic gather 5 (e.g., a CIP seismic gather) produced by a velocity model is shown illustrating an example of irreducible depth uncertainty. Unlike the seismic gather 1 shown in FIG. 1, the seismic gather 5 of FIG. 2 has no observable curvature along the X-axis thereof. However, in this example, seismic gather 5 includes irreducible depth uncertainty which is not manifested in the curvature of seismic gather 5. Indeed, multiple separate velocity models with different corresponding depth predictions may produce seismic gathers similar to seismic gather 5 and each subject to irreducible depth uncertainty that does not manifest as curvature of the seismic gather 5. An important contributor to irreducible depth uncertainty is the trade-off between the impacts of velocity and anisotropy in seismic imaging.

Particularly, subsurface regions of the Earth may be anisotropic, where the term “anisotropic” corresponds to the degree of directional variation in homogeneity of a given material such that observations of the material are affected by the material's orientation-in other words, the material's degree of directionality. The anisotropy of an Earthen material (e.g., a subsurface region) may simply be characterized using three separate parameters-anisotropic delta, anisotropic epsilon, and anisotropic gamma. Particularly, anisotropic delta refers to the “short offset effect” captured by the relationship between the velocity required to flatten a given seismic gather (e.g., the normal moveout (NMO) velocity) and the zero-offset average velocity (e.g., as determined using checkshots). Reducible depth uncertainty is contingent on the velocities used to migrate the seismic data to form the given seismic gather, and thus by adjusting the anisotropy delta a curved seismic gather manifesting reducible depth uncertainty may be “flattened” to eliminate the reducible depth uncertainty without addressing the underlying error. Instead, the underlying error or uncertainty is shifted from being reducible depth uncertainty observable in curved seismic gathers to irreducible depth uncertainty that can no longer be observed in the seismic gathers

As indicated in FIGS. 1 and 2, reducible depth uncertainty is directly observable from seismic gathers and can (when observed), to some extent, be ameliorated by improved data processing. Conversely, irreducible depth uncertainty remains hidden, which can lead to false confidence during resource characterization and well planning.

Further, while more sophisticated approaches have been recently developed for estimating depth uncertainty, such approaches generally suffer from their complexity and cost, making them difficult to implement in a broad range of applications by different end users. For example, some more sophisticated conventional approaches estimate depth uncertainty from seismic tomography and full-waveform inversion using Bayesian methods. However, proper posing of velocity uncertainty in a Bayesian framework is far from straightforward and a poorly chosen prior may lead to inaccurate results, making such an approach difficult to implement particularly by non-experts. Additionally, rigorous treatment of errors in imaging velocity may draw focus away from appropriate treatment of errors in anisotropy, which can have a major impact on imaged depth. Further, Bayesian and FWI-based methods for quantifying depth uncertainty are often computationally expensive and inaccessible to non-specialist end users-including those end users who will ultimately be responsible for integrating the resulting uncertainties into resource models and well plans.

Accordingly, embodiments described herein, are directed to simpler methods and apparatuses for estimating seismic depth uncertainty. In some embodiments, methods for estimating seismic depth uncertainty disclosed herein are based entirely on post-migration seismic data. As used herein, the term “post-migration seismic data” refers to seismic data relocated to the specific subsurface location at which a subsurface event occurred (e.g., the reflection of a seismic signal off of a subsurface reflector) rather than the surface location at which the event was recorded by a seismic receiver. Conversely, as used herein, the term “pre-migration seismic data” refers to seismic data that corresponds to the specific surface location and relative time at which a subsurface event was recorded by a seismic receiver rather than the subsurface location where the subsurface event occurred.

Pre-migration seismic data may be “migrated” by converting the pre-migration seismic data into post-migration seismic data. For example, the pre-migration seismic data may be migrated by applying a wave-equation migration process to obtain the migrated seismic data such as a reverse time migration (RTM) process, a one-way wave-equation migration (WEM) process, or a Kirchhoff depth migration process. Conversely, post-migration seismic data may be “de-migrated” by converting the post-migration seismic data into pre-migration seismic data. In some embodiments, post-migration seismic data may be de-migrated (i.e., in a one-dimensional sense), by applying a vertically transverse isotropic (VTI) anisotropic processing model to the post-migration seismic data using an analytic relationship to determine seismic signals through a medium for different depths and offsets. In some embodiments, a synthetic seismic gather in the time-domain is generated from the travel-time table using a wavelet with peak frequencies inherited from an initial velocity model that provided the existing post-stack seismic data.

In some embodiments, methods for estimating seismic depth uncertainty employ a stochastic process that estimates a set of changes in anisotropic velocity required to perceptibly “un-flatten” or remove curvature from the synthetic seismic gather to thereby estimate the irreducible portion of the seismic depth uncertainty. In some embodiments, this process may be simplified by considering each seismic gather independently and/or by employing synthetic gathers rather than actual pre-stack seismic gathers obtained directly from the migration of a collection of seismic traces collected in the field. These simplifications may increase the accessibility and broaden the range of applications for the process such that the process is more easily incorporated into existing workflows of the end user.

In certain embodiments, a method for estimating uncertainty in seismic-derived depth prognoses of a subsurface region includes performing a one-dimensional seismic de-migration on initial post-migration seismic data obtained from an initial velocity model to obtain pre-migration seismic data, and perturbing one or more of the components of the initial velocity model to produce a plurality of perturbed velocity models that are each different from the initial velocity model. In some embodiments, the pre-migration seismic data comprises synthetic seismic gathers that are derived from a time-travel table and a post-stack seismic volume rather than directly from the pre-stack or post-migration seismic data itself in order to minimize the computational complexity involved in implementing the method.

In some embodiments, methods for estimating uncertainty include performing a one-dimensional seismic migration of the pre-migration seismic data using the perturbed velocity model to obtain perturbed post-migration seismic data for each of the plurality of perturbed velocity models, and estimating a depth error from a depth prognosis obtained from at least some of the perturbed velocity models selected based on the flatness of the post-migration seismic gathers calculated using the perturbed velocity models. The method may additionally include estimating a depth uncertainty from the depth error. In certain embodiments, the predefined criterion is based on the measured residual moveout of the seismic traces of perturbed seismic gathers. In other embodiments, the predefined criterion may be based on a semblance of the perturbed seismic gathers. In either case, the perturbed velocity models may be divided, in accordance with the flatness of their corresponding perturbed seismic gathers, between an acceptable group of perturbed velocity models used in estimating the depth uncertainty and an unacceptable group of perturbed velocity models not used in estimating the depth uncertainty. In certain embodiments, the estimated depth uncertainty is taken as a predefined percentile of a distribution of depth prognoses obtained from the acceptable group of perturbed velocity models.

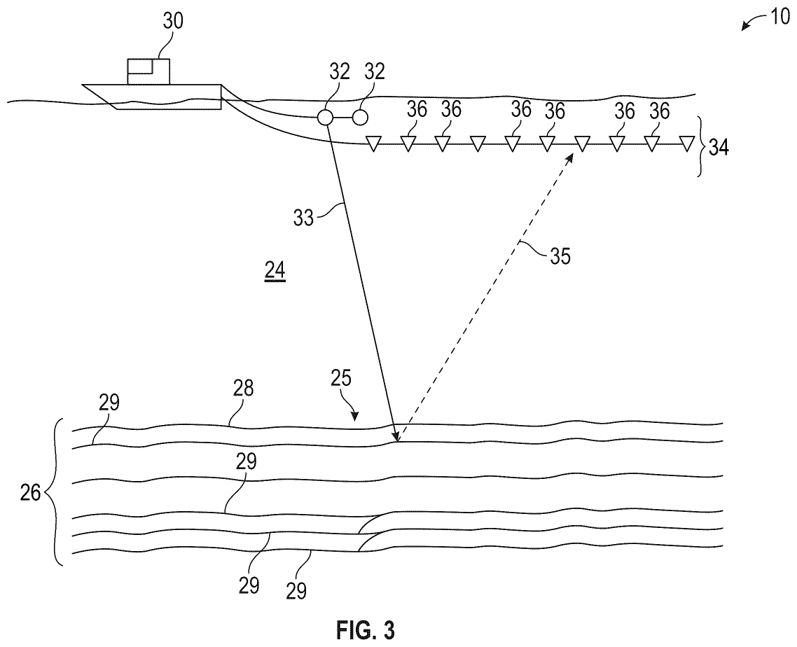

Referring now to FIG. 3, an embodiment of a marine survey system 10 that may be employed to acquire seismic data (e.g., waveforms) regarding a subsurface region of the Earth in a marine environment is shown. Generally, a marine seismic survey conducted using the marine survey system 10 shown in FIG. 3 may be conducted in an ocean 24 or other body of water over a subsurface region 26 of the Earth that lies beneath a seafloor 28. In this exemplary embodiment, marine survey system 10 generally includes a marine vessel 30 at the surface of the ocean 24, one or more seismic sources 32, a seismic streamer 34, one or more seismic receivers 36, and/or other equipment that may assist in acquiring seismic images representative of geological formations within the subsurface region 26 of the Earth.

The marine vessel 30 tows the seismic sources 32 (e.g., an array of air guns) over an area of interest (AOI) 25 of the subsurface region as the seismic sources 32 repeatedly produce sound waves (e.g., emitted seismic waves indicated by arrow 33 in FIG. 3) that are directed at the seafloor 28 and towards the AOI 25. As the emitted seismic waves 33 penetrate through the subsurface region 26, some of the seismic energy of the seismic waves 33 is reflected off of one or more subsurface reflectors 29 formed within the subsurface region 26 such that the reflected seismic energy (e.g., reflected seismic waves indicated by arrow 35 in FIG. 3) travels back towards the surface of the ocean 24. In general, subsurface reflectors 29 of subsurface region 26 may comprise a variety of diverse geological features and formations including, for example, salt domes, faults, folds, interfaces between different subsurface materials, and other features.

As the marine vessel 30 tows the seismic sources 32 over the AOI 25, the marine vessel 30 may concurrently tow the seismic receivers 36 (e.g., hydrophones), which detect and capture the reflected seismic waves 35 that represent the energy output by the seismic sources 32 subsequent to being reflected off of the reflectors 29 within the subsurface region 26. The reflected seismic waves 35 captured by seismic receivers 36 comprises seismic data that may be processed by a computer system to generate one or more images and/or velocity models associated with the subsurface region 26. For example, images constructed from the captured seismic data may visually depict various features of the subsurface region 26 including at least some of reflectors 29 of the subsurface region 26. Additionally, velocity models constructed from the captured seismic data may be used to estimate the vertical depth (from the seafloor 28) of various features of the subsurface region 26 including the vertical depth of at least some of the reflectors 29 thereof.

The images, velocity models, and other information gleaned from the captured seismic data may be utilized in locating hydrocarbon deposits within subsurface region 26. For example, the captured seismic data may be analyzed to generate a map or profile that illustrates various geological formations within the subsurface region 26. Based on the identified locations and properties of the hydrocarbon deposits determined from the captured seismic data, certain positions or parts (e.g., AOI 25) of the subsurface region 26 may be explored. That is, hydrocarbon exploration organizations may use the locations of the hydrocarbon deposits to determine locations at the surface (seafloor 28 in this exemplary embodiment) of the subsurface region 26 to drill into the Earth. As such, the hydrocarbon exploration organizations may use the locations and properties of the hydrocarbon deposits and the associated overburdens to determine a path along which to drill into the Earth, how to drill into the Earth, and the like. After exploration equipment has been placed within the subsurface region, the hydrocarbons that are stored in the identified hydrocarbon deposits may be produced via natural flowing wells, artificial lift wells, and the like.

It may be understood that the number of seismic sources 32 and the number of seismic receivers 36 of the marine survey system 10 may vary depending on the given application. In the same manner, although marine survey system 10 is described with one seismic streamer 34, it should be noted that the marine survey system 10 may include multiple streamers similar to streamer 34. Additionally, while seismic sources 32 are described as air guns and seismic receivers 36 are described as hydrophones in this exemplary embodiment, the configuration of sources 32 and receivers 36 may vary in other embodiments. Further, additional marine vessels 30 may include additional seismic sources 32, seismic streamers 34, and the like to perform the operations of the marine survey system 10.

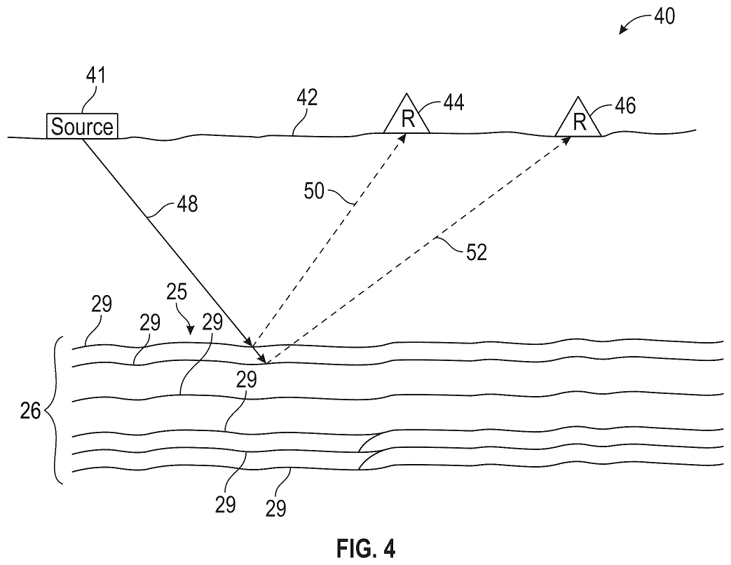

Referring now to FIG. 4, an embodiment of a land survey system 40 that may be employed to obtain information, including captured seismic data, regarding the subsurface region 26 of the Earth in a non-marine environment. In this exemplary embodiment, land survey system 40 generally includes a land-based seismic source 41 and a land-based receiver 44. In some embodiments, the land survey system 40 may include multiple land-based seismic sources 40 and one or more land-based receivers 44, 46. Indeed, for discussion purposes, the land survey system 40 includes a land-based seismic source 41 and two land-based receivers 44, 46.

The land-based seismic source 41 (e.g., a seismic vibrator) of land survey system 40 may be disposed on a surface 42 of the Earth above the subsurface region 26 of interest. The land-based seismic source 41 may produce energy (e.g., emitted seismic waves indicated by arrow 48 in FIG. 4) that is directed at the subsurface region 26 of the Earth. Upon reaching various subsurface reflectors 29 (e.g., salt domes, faults, folds, interfaces) within the subsurface region 26, the energy output by the land-based seismic source 41 may be reflected (e.g., reflected seismic waves indicated by arrows 50, 52 in FIG. 4) off of the subsurface reflectors 29, and captured by one or more land-based seismic receivers (e.g., seismic receivers 44 and 46).

In some embodiments, the land-based seismic receivers 44, 46 may be dispersed across the surface 42 of the Earth to form a grid-like pattern. As such, each land-based seismic receiver 44, 46 may receive a reflected seismic wave 50, 52 in response to energy being directed at the subsurface region 26 via the seismic source 41. In some cases, one seismic waveform produced by the seismic source 41 may be reflected off of different subsurface reflectors 29 and received by different seismic receivers 44, 46. For example, as shown in FIG. 4, a first seismic receiver 44 may receive the reflection of the emitted seismic waveform 48 off of a first reflector 29 while a second seismic receiver 46 may receive the reflection of the seismic waveform 48 off of a second reflector 29. As such, the first seismic receiver 44 may receive a reflected seismic wave 50 and the second seismic receiver 46 may receive a reflected seismic wave 52.

Regardless of how the seismic data is acquired, a computer system may analyze the seismic waveforms acquired by the seismic receivers (e.g., seismic receivers 36, 44, and 46 of survey systems 10, 40 described above) to determine seismic information regarding the geological structure, the location and property of hydrocarbon deposits, and the like within the subsurface region 26.

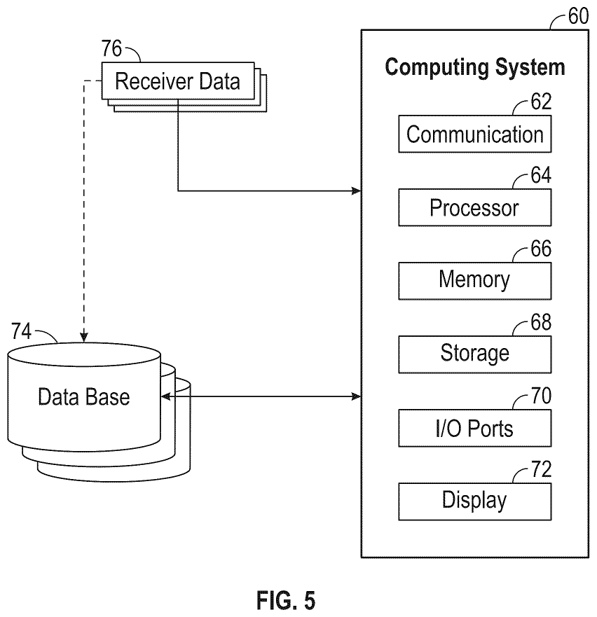

Referring now to FIG. 5, a block diagram of an embodiment of such a computer system 60 that may perform various data analysis operations to analyze the seismic data acquired by the receivers 36, 44, and 46 to determine the structure and/or predict seismic properties of the geological formations within the subsurface region 26 is shown. In this exemplary embodiment, computer system 60 generally includes a communication component 62, a processor 64, memory 66, storage 68, input/output (I/O) ports 70, and a display 72. In some embodiments, the computer system 60 may omit one or more of the display 72, the communication component 62, the (I/O) ports 70, or combinations thereof. The communication component 62 may be a wireless or wired communication component that may facilitate communication between the seismic receivers (e.g., seismic receivers 36, 44, and 46), one or more databases 74, other computing devices, and/or other communication capable devices. In one embodiment, the computer system 60 receives receiver data 76 (e.g., captured seismic data, seismograms) via a network component, databases 74, or the like. The processor 64 of the computer system 60 executes instructions stored on the memory 66 to analyze or process the receiver data 76 to ascertain various features regarding geological formations within the subsurface region 26. As will be discussed further herein, processor 64 particularly executes instructions stored on memory 66 to construct one or more images and/or one or more velocity models of the subsurface region 26.

In general, the processor 64 may be any type of computer processor or microprocessor capable of executing computer-executable code. The processor 64 may also include multiple processors that may perform the operations described below. In general, the memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 executes software applications that include programs that process seismic data acquired via receivers of a seismic survey according to the embodiments described herein.

The memory 66 and the storage 68 are also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 are interfaces that couple to other peripheral components such as input devices (e.g., keyboard, mouse), sensors, input/output (I/O) modules, and the like. I/O ports 70 enable the computer system 60 to communicate with the other devices in the marine survey system 10, the land survey system 40, or the like via the I/O ports 70.

The display 72 depicts visualizations associated with software or executable code being processed by the processor 64. In one embodiment, the display 72 is a touch display capable of receiving inputs from a user of the computer system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. In general, the display 72 may be any suitable type of display, such as a liquid crystal display (LCD), plasma display, or an organic light emitting diode (OLED) display, for example. In addition to depicting the visualization described herein via the display 72, it should be noted that the computer system 60 may also depict the visualization via other tangible elements, such as paper (e.g., via printing) and the like.

With the foregoing in mind, the present techniques described herein may also be performed using a supercomputer that employs multiple computer systems 60, a cloud-based computer system, or the like to distribute processes to be performed across multiple computer systems 60. In this case, each computer system 60 operating as part of a supercomputer may not include each component listed as part of the computer system 60. For example, each computer system 60 may not include the display 72 since multiple displays 72 may not be useful to for a supercomputer designed to continuously process seismic data.

After performing various types of seismic data processing, the computer system 60 may store the results of the analysis in one or more databases 74. The databases 74 may be communicatively coupled to a network (e.g., a wide area network like the Internet) that may transmit and receive data to and from the computer system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computer system 60, it should be noted that similar components may make up the computer system 60. Moreover, the computer system 60 may also be part of the marine survey system 10 and/or the land survey system 40, and thus may monitor and control certain operations of the seismic sources 32 or 41, the seismic receivers 36, 44, and 46, and the like. Further, it should be noted that the listed components are provided as example components and the embodiments described herein are not to be limited to the components described with reference to FIG. 5.

In some embodiments, the computer system 60 generates a two-dimensional representation or a three-dimensional representation of the subsurface region 26 based on the seismic data received via the receivers mentioned above. Additionally, seismic data associated with multiple seismic source/receiver combinations may be combined to create a near continuous profile of the subsurface region 26 that can extend for some distance. In a two-dimensional (2D) seismic survey, the receiver locations may be placed along a single line, whereas in a three-dimensional (3D) survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26. In either case, a seismic survey may be composed of a very large number of individual seismic recordings or traces. As such, the computer system 60 may be employed to analyze the acquired seismic data to obtain an image representative of the subsurface region 26 and, using the obtained image, determine locations and properties of desired hydrocarbon deposits within the subsurface region 26 which may be later extracted. To that end, a variety of seismic data processing algorithms may be used to remove noise from the acquired seismic data, migrate the pre-processed seismic data, identify shifts between multiple seismic images, align multiple seismic images, and the like.

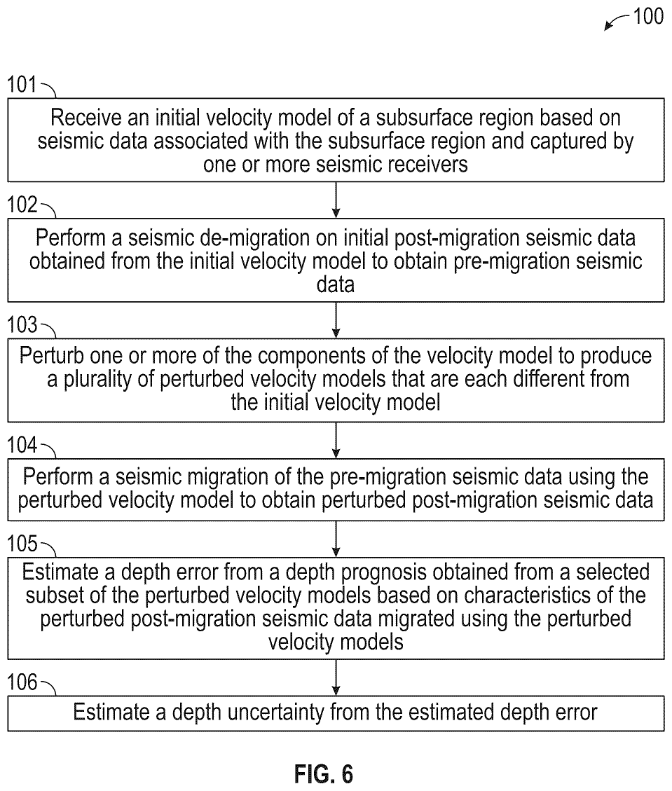

Referring now to FIG. 6, an embodiment of a method 100 for estimating uncertainty in seismic-derived depth prognoses of a subsurface region is shown. At least some, if not all, of the steps or “blocks” of method 100 shown in FIG. 6 may be executed by the computer system 60 shown in FIG. 5, although it is to be understood that at least some of the steps of method 100 may be executed by systems other than computer system 60. Additionally, it is to be understood that depth uncertainties estimated from method 100 may be used for a variety of purposes, including the planning of one or more wells which would extend through the subsurface region.

Beginning at block 101, method 100 includes receiving an initial velocity model of a subsurface region based on seismic data associated with the subsurface region and captured by one or more seismic receivers. The velocity model may comprise one or more components including, for example, a velocity component, an anisotropy epsilon component, and an anisotropy delta component. In some embodiments, the velocity model provides the interval velocity of the subsurface region thereby translating the time-domain seismic data into depth-domain data. The velocity may be obtained in the form of normal moveout (NMO) velocity or by an inversion process such as in full-waveform inversion (FWI).

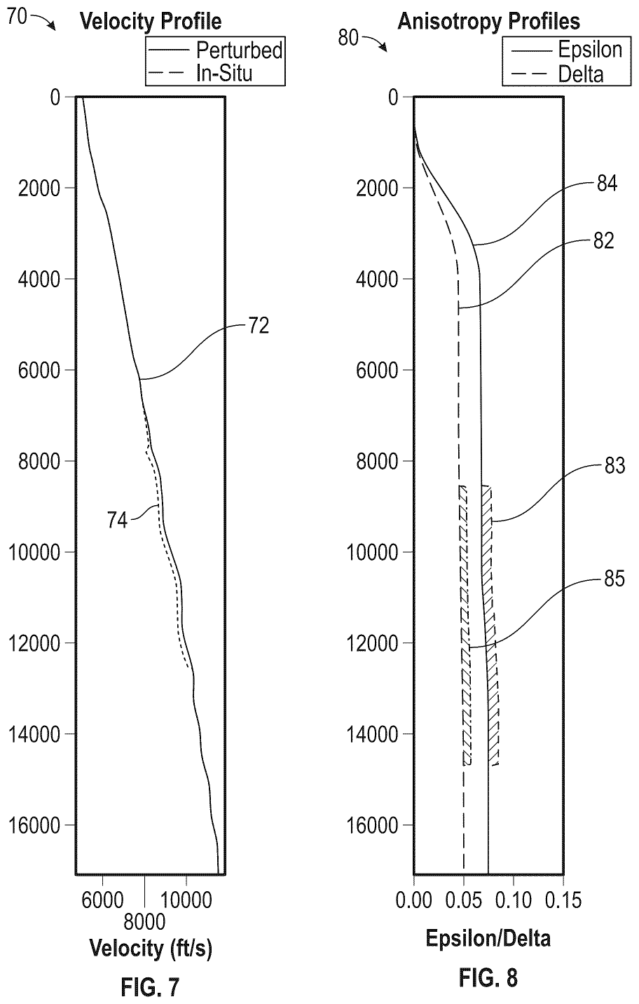

Referring now to FIGS. 7 and 8, an exemplary initial velocity model with velocity and anisotropy (epsilon/delta) components is shown. FIG. 7 particularly includes a velocity profile graph 70 illustrating a seismic velocity component 72 of the initial velocity model. Velocity profile graph 70 has a Y-axis that corresponds to vertical depth of a subsurface region in feet (ft) and an X-axis corresponding to estimated seismic velocity in units of feet per second (ft/s). In some embodiments, the initial velocity model may, along with modelling seismic velocity through the subsurface region, model the anisotropy of the subsurface region. For example, the initial velocity model may include a short offset effect (anisotropic delta) component and a long offset effect (anisotropic epsilon) component. The anisotropic components of the initial velocity model may be obtained using a VTI anisotropic processing model. The migration of the seismic traces may use all three components (velocity, epsilon, and delta) to calculate a 3D relationship between the acoustic travel time and subsurface location, which may then be used to position seismic reflections recorded in time into their correct locations in depth.

As an example, and referring now to FIG. 8, an exemplary anisotropy profile graph 80 is shown. Particularly, anisotropy profile graph 80 has a Y-axis corresponding to depth in feet (ft) and a dimensionless X-axis corresponding to the magnitude of the given anisotropy (delta/epsilon) component. In this example, anisotropy profile graph 80 includes a first curve 82 corresponding to an anisotropic delta component 82 of the initial velocity model as a function of vertical depth. Additionally, anisotropy profile graph 80 includes a second curve 84 corresponding to an anisotropic epsilon component 84 of the initial velocity model.

Returning to FIG. 6, at block 102, method 100 comprises performing in a simplified one-dimensional sense, a seismic de-migration of post-migration seismic data obtained from the initial velocity model to obtain de-migrated seismic data. The pre-migration seismic data that is de-migrated at block 102 may be based on the components of the initial velocity model such as the velocity component, the anisotropy epsilon component, and the anisotropy delta component of the initial velocity model.

In certain embodiments, block 102 comprises producing or determining a travel-time table using the VTI anisotropic processing model (e.g., the model used to create anisotropy profile graph 80 shown in FIG. 8) and a pre-defined analytic relationship. The travel-time table produced at block 102 may indicate estimated travel-time of seismic signals through the subsurface region modeled by the initial velocity model for different depths and offsets. In other embodiments, the travel-time table may be produced using the VTI anisotropic processing model and a ray tracing method.

In some embodiments, block 102 additionally includes using the produced travel-time table to generate a synthetic (time-domain) seismic gather. A synthetic seismic gather may be utilized in lieu of actual or “true” seismic gathers based directly on obtained seismic traces to provide a solution that is quick, computationally inexpensive, and which may be implemented from only a seismic stack and a corresponding velocity model.

In some embodiments, the synthetic seismic gather is generated using a wavelet and frequency information based on the stacked seismic data of the subsurface region. For example, the wavelet may comprise a Ricker wavelet (e.g., a Mexican hat wavelet) and the frequency information may comprise peak frequencies inherited from post-stack seismic data of the subsurface region.

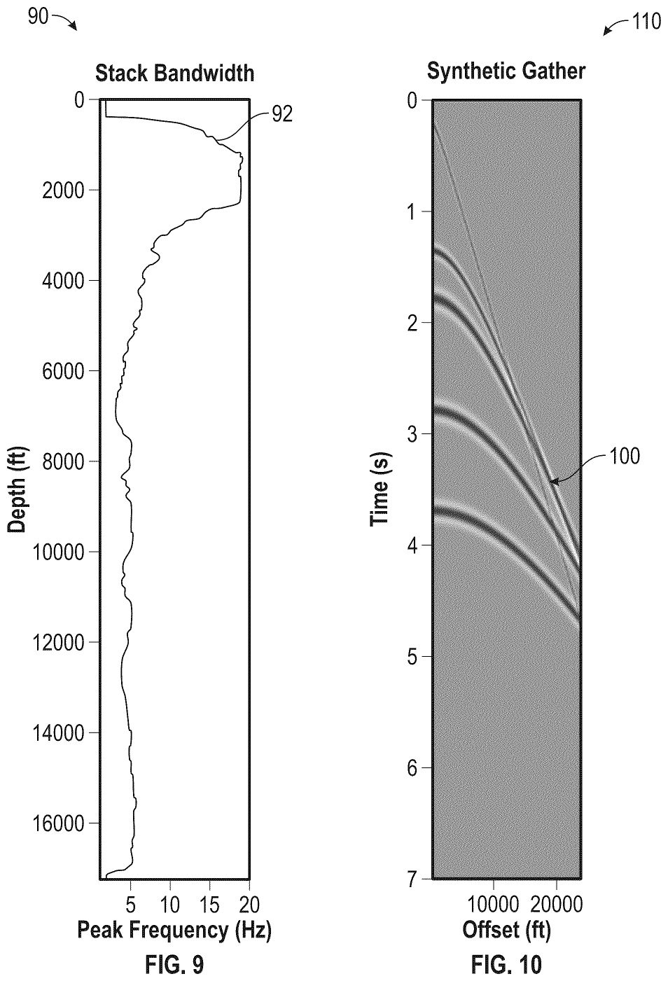

As an example, and referring now to FIGS. 9 and 10, an exemplary stack bandwidth graph 90 is shown in FIG. 9 while an exemplary synthetic seismic gather 110 is shown in FIG. 10. The stack bandwidth graph 90 contains frequency information of seismic data sourced from a subsurface region. Particularly, the frequency information presented in graph 90 is from post-stack seismic data. The post-stack seismic data may comprise a seismic stack formed by combining or “stacking” a plurality of seismic gathers whereby the seismic traces form a plurality of seismic gathers. For example, to produce a CDP seismic stack, after acquiring a plurality of CDP seismic gathers covering a range of offsets and midpoints, the seismic traces of multiple CDP seismic gathers that share the same midpoint may be summed or averaged. The CDP seismic stack defines a composite image that enhances the signal-to-noise, providing a clearer representation of the subsurface region.

Returning to stack bandwidth graph 90, graph 90 includes a curve comprising peak frequencies 92 of the post-stack seismic data (e.g., a CDP seismic stack formed from a plurality of CDP seismic gathers). Particularly, stack bandwidth graph 90 has a Y-axis that corresponds to vertical depth in feet (ft) and an X-axis corresponding to peak frequency in hertz (Hz). Synthetic seismic gather 110 comprises de-migrated synthetic data having a Y-axis corresponding to time in seconds(s) and an X-axis corresponding to offset in feet (ft). The maximum offsets and angle mutes obtained are guided by the acquisition and real data processing flow. The synthetic seismic gather 110 (e.g., a synthetic CDP seismic gather) 110 may be produced from or based on the peak frequencies 92 of stack bandwidth graph 90, along with the travel-time table and the wavelet described above. The synthetic seismic gather 110 comprises pre-migration seismic data that has been obtained at block 102 of method 100 from post-migration seismic data from the initial velocity model, such as post-migration seismic data based on the velocity component, and the anisotropy epsilon component, and/or the anisotropy delta component of the initial velocity model.

Referring again to FIG. 6, method 100 continues to block 103 with perturbing one or more of the components of the initial velocity model to produce a plurality of perturbed velocity models that are each different from the initial velocity model. The plurality of perturbed velocity models may each have at least one of a velocity component, an anisotropy epsilon component, and an anisotropy delta component that varies from the velocity component, the anisotropy epsilon component, and the anisotropy delta component of the initial velocity model.

As an example, in some embodiments, each of the velocity, anisotropy epsilon, and anisotropy delta components of the initial velocity model may be perturbed randomly and independently to produce the plurality of perturbed velocity models. As used herein, the term “perturbations” refers to random errors that are synthetically injected into the initial velocity model. The perturbations may be introduced in any form.

As an example, the velocity profile graph 70 shown in FIG. 7 includes the initial velocity component 72 corresponding to an initial velocity model, and a perturbed velocity component 74 that is formed by introducing perturbations or “perturbing” the initial velocity component 72 across a predefined depth range (e.g., between 8,000 ft and 12,500 ft in graph FIG. 7). As indicated in FIG. 7, the perturbed velocity component 74 is different from the initial velocity component 72 across the predefined depth range. As another example, the anisotropy profile graph 80 shown in FIG. 8 includes the initial anisotropy component 82 and 84 corresponding to the initial velocity model, and corresponding perturbed anisotropy components 83 and 85 that are formed by introducing perturbations or “perturbing” the initial anisotropy components 82 and 84 across a predefined depth range (e.g., between 8,500 ft and 14,500 ft in graph FIG. 8). In this example, the perturbed anisotropy delta component 85 is different from the initial anisotropy delta component 82 while the perturbed anisotropy epsilon component 85 is different from the initial anisotropy epsilon component 84.

Returning to FIG. 6, at block 104, method 100 includes for each of the plurality of perturbed velocity models, performing a seismic migration of the pre-migration seismic data using the perturbed velocity model to obtain perturbed post-migration seismic data. In some embodiments, the travel-time table determined at block is redetermined at block 104 to obtain a perturbed travel-time table corresponding to a respective perturbed velocity model (e.g., a first perturbed travel-time table corresponding to a first perturbed velocity model, a second perturbed travel-time table corresponding to a second perturbed velocity model). Each of the resulting perturbed travel-time tables may be used to migrate the pre-migration seismic data (e.g., in the form of time-domain seismic gathers) to the depth domain in a simple one-dimensional sense.

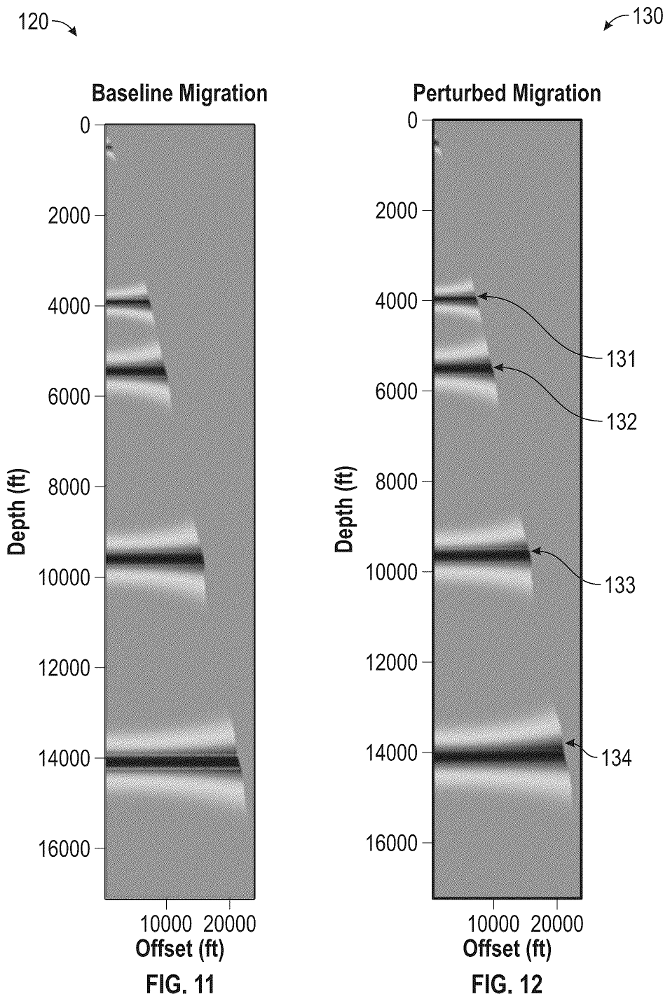

Referring now to FIGS. 11 and 12, exemplary post-migration seismic data is shown. Particularly, FIG. 11 illustrates a baseline seismic gather 120 having a Y-axis corresponding to depth in feet (ft) and an X-axis corresponding to offset in feet (ft). The baseline seismic gather 120 is an example of a baseline or initial seismic gather 120 that may be obtained from the initial velocity model received at block 101. Additionally, FIG. 12 includes a perturbed seismic gather 130 similarly having a Y-axis corresponding to depth in feet (ft) and an X-axis corresponding to offset in feet (ft). The perturbed seismic gather 130 is an example of a perturbed seismic gather that may be obtained from block 104 (e.g., perturbed seismic gather 130 is an example of the post-migration seismic data that may be obtained at block 104).

At block 105, method 100 comprises estimating a depth error from a depth prognosis obtained from a selected subset of the perturbed velocity models based on characteristics of the perturbed post-migration seismic data migrated using the perturbed velocity models. The characteristics of the perturbed post-migration seismic data as used herein, refers to the flatness or how flat the gathers are. In some embodiments, block 105 includes filtering the plurality of perturbed velocity models obtained at block 103 by applying a predefined threshold criterion to the perturbed post-migration seismic data obtained from the perturbed velocity models. In this manner, those perturbed velocity models having perturbed post-migration seismic data that fail the threshold criterion are discarded while those perturbed velocity models having perturbed post-migration seismic data that passes the threshold criterion are accepted as part of a selected subset of perturbed velocity models.

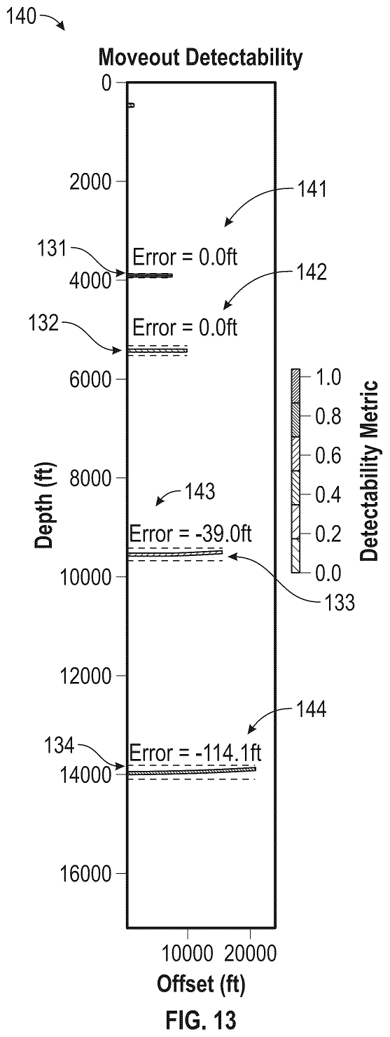

The threshold criterion may be designed to mirror the type of analysis normally performed manually by a seismic data processor. For instance, the threshold criterion may be designed to consider the tolerance for error that would typically be acceptable in real-world applications by seismic data processors. In some embodiments, the perturbed post-migration seismic data takes the form of a plurality of perturbed seismic gathers and the threshold criterion is based on the residual moveout or curvature of the seismic reflections recorded in the traces of the perturbed seismic gather. In certain embodiments, the threshold criterion may comprise the amount of residual moveout as a fraction of wavelet width for each perturbed seismic gather. However, the form of the threshold criterion may vary. To provide an example, and referring briefly to FIG. 13, a moveout detectability graph 140 is shown having a Y-axis corresponding to depth in feet (ft) and an X-axis corresponding to offset in feet (ft). Moveout detectability graph 140 contains representations of the perturbed seismic traces 131-134 from perturbed seismic gather 130 of FIG. 12 along with an estimated error 141-144 corresponding to the amount of residual moveout or curvature 141-144 of the given perturbed seismic trace 131-134. Thus, in some embodiments, the residual moveout 141-144 may be divided by the wavelet width and applied to the threshold criterion to determine whether the perturbed velocity model from which perturbed seismic gather 130 was obtained passes or fails the threshold criterion. For example, a user may either be strict and demand all perturbed velocity models pass the threshold, or allow some fraction (e.g., 10%) of the perturbed velocity models to fail by a small, pre-defined margin.

Referring again to FIG. 6, in some embodiments, block 105 includes determining a depth prognosis for one or more subsurface features of a subsurface region based on the perturbed velocity models which passed the threshold criterion. As used herein, the term “depth prognosis” refers to a depth of a selected subsurface feature of a subsurface region estimated using a velocity model of the subsurface region. In some embodiments, block 105 includes determining a distribution of depth prognoses for one or more selected subsurface features of the subsurface region.

At block 106, method 100 comprises estimating a depth uncertainty from the estimated depth error. The depth uncertainty estimated at block 106 for a selected subsurface feature may comprises a predefined percentile of the distribution of depth prognoses of the selected subsurface feature. For example, in some embodiments, the difference between the 90th percentile of the distribution of depth prognoses and the reference depth as determined by the unperturbed velocity model, may be taken as the depth uncertainty for the estimated depth of a selected subsurface feature. However, the percentile taken as the depth uncertainty may vary in other embodiments. For instance, in some embodiments, the 85th percentile of the distribution of depth prognoses may be taken as the depth uncertainty for the estimated depth of a selected subsurface feature. In other embodiments, the 95th percentile of the distribution of depth prognoses may be taken as the depth uncertainty for the estimated depth of a selected subsurface feature.

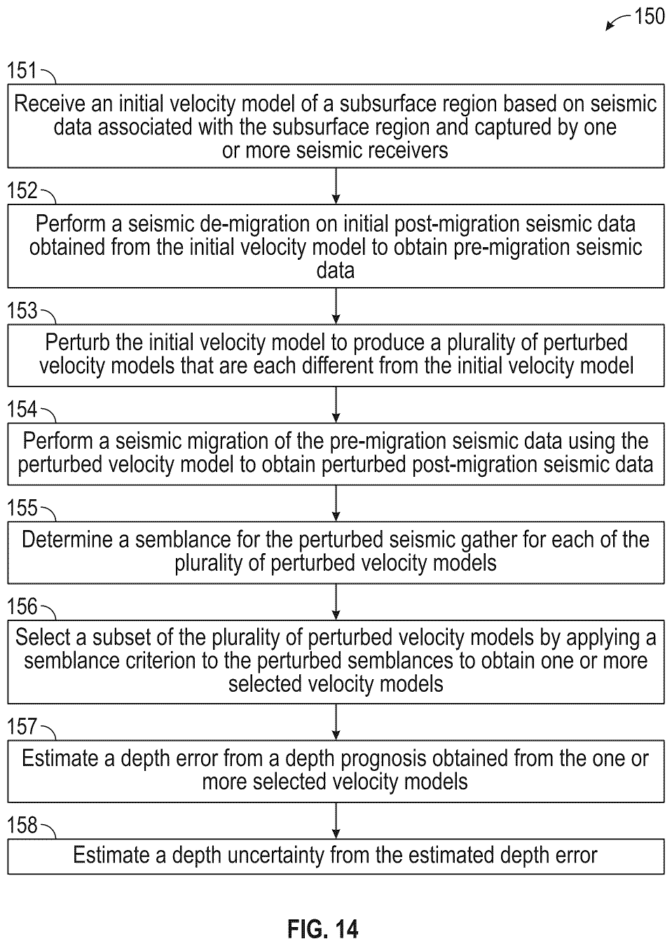

Referring now to FIG. 14, another embodiment of a method 150 for estimating uncertainty in seismic-derived depth prognoses of a subsurface region in accordance with embodiments described herein is shown. At least some, if not all, of the steps or “blocks” of method 150 shown in FIG. 14 may be executed by the computer system 60 shown in FIG. 5, although it is to be understood that at least some of the steps of method 150 may be executed by systems other than computer system 60. Particularly, in some embodiments, method 150 may be used to estimate, in addition to uncertainty in seismic-derived depth prognoses of a subsurface region, residual moveout and pre-stack data quality based on the difference between observed seismic data and moveout corrected data. Residual moveout as used herein, refers to changes in the migrated depths of reflected seismic waves as a function of offset (distance between the source and receiver). In addition, and as further discussed below, method 150 may incorporate at least some of the features or steps of method 100 described above and shown in FIG. 6.

The method 150 begins at block 151, with receiving an initial velocity model of a subsurface region based on seismic data associated with the subsurface region and captured by one or more seismic receivers. As described above, the velocity model may comprise one or more components including, for example, a velocity component, an anisotropy epsilon component, and an anisotropy delta component. Method 150 continues at block 152 with performing a seismic de-migration of initial post-migration seismic data obtained from the initial velocity model to obtain pre-migration seismic data. The pre-migration seismic data that is obtained at block 152 may be based on the components of the initial velocity model. Unlike block 102 of method 100, in this exemplary embodiment, block 152 does not include generating a synthetic seismic gather and instead relies on true seismic gathers obtained directly from the seismic data referenced at block 151. Replacing the synthetic seismic gather with the true seismic gather may, at the expense of additional computational complexity, increase the accuracy of the estimation of the depth uncertainty. In some applications, it may be desirable to obtain the most accurate estimation of depth uncertainty possible even at the cost of increased computational complexity. However, in other applications, it may be preferred to instead minimize computation complexity (e.g., due to limited availability of computational resources) when estimating the depth uncertainty.

At block 153, method 150 includes perturbing one or more of the components of the initial velocity model to produce a plurality of perturbed velocity models that are each different from the initial velocity model. As described above, each of the components of the initial velocity model may be perturbed randomly and independently to produce the plurality of perturbed velocity models. Method 150 continues at block 154 with performing a seismic migration of the pre-migration seismic data using the perturbed velocity models to obtain perturbed post-migration seismic data.

At block 155, method 150 includes determining a perturbed semblance for a perturbed seismic gather for each of the perturbed velocity models. Generally, “semblance” is a measure of the coherency of seismic energy across different seismic traces of a given seismic gather. Normally, the semblance of a seismic gather (e.g., the perturbed seismic gathers of the perturbed velocity models) may be calculated using semblance panels which involve sliding a window across post-stack seismic data and determining a semblance value for each window position. The calculated semblance values are often displayed as semblance maps or semblance sections (referred to herein simply as “semblance”). For example, a user may choose to quantify the reduction in semblance that results from the gather becoming less flat after the velocity model is perturbed by examining the average fractional reduction in semblance of the peaks of the semblance function which corresponds to the reflections with the least noise contamination. As another example, a user may choose to quantify exactly how many of the semblance estimates fall outside some global distribution of semblance as a function of depth.

Method 150 continues at block 156 with selecting a subset of the perturbed velocity models by applying a semblance criterion to the perturbed semblances to obtain one or more selected velocity models. The semblance criterion could be based on reaching a satisfactory semblance value (the less flat the gather, the lower the semblance value), achieving a certain level of data fit, or applying other criteria specific to the seismic analysis as disclosed in the examples above.

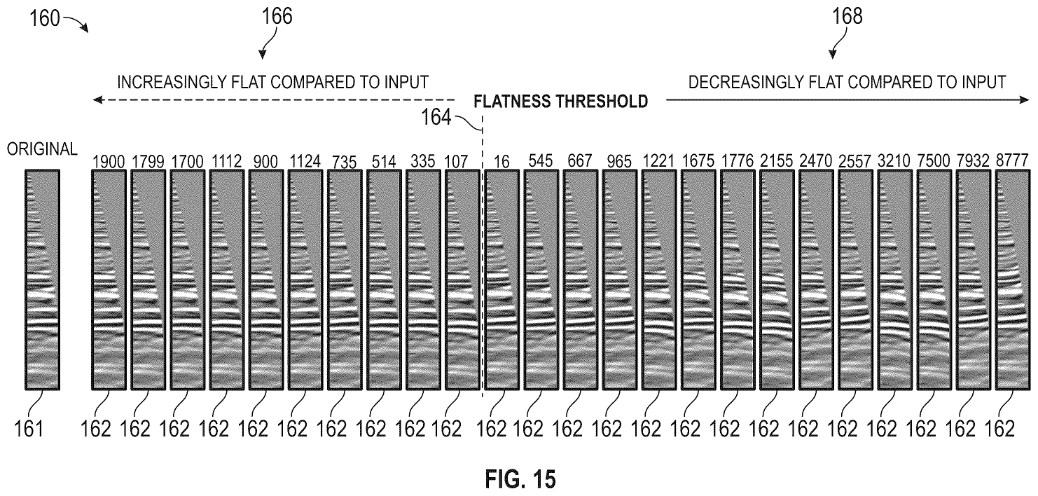

In some embodiments, block 156 includes arranging or ranking the perturbed seismic gathers in accordance with their respective semblances and using the semblance criterion to divide the ranked perturbed semblance gathers between a “flat” or accepted group and an “un-flat” or rejected group. To provide an example, and referring briefly to FIG. 15, a diagram 160 is shown of exemplary perturbed seismic gathers 162 (along with an initial seismic gather 161) arranged or ranked in order of flatness as determined by their respective semblances. A semblance criterion or flatness threshold 164 is applied to define the set of acceptable velocity models corresponding to an accepted group 166 of the perturbed seismic gathers 162 that can be used to estimate depth uncertainty and which are contra a rejected group 168 of the perturbed seismic gathers 162 that cannot be used to estimate depth uncertainty. The processes of blocks 155 and 156 may be repeated multiple times until a satisfactory model selection is obtained based on a user controllable metric.

Method 150 continues at block 157 with estimating a depth error from a depth prognosis obtained from the one or more selected velocity models. Further, method 150 continues at block 158 with estimating a depth uncertainty from the estimated depth error. In some embodiments, block 158 includes estimating the reducible depth uncertainty from block 157, in addition to the irreducible depth uncertainty, provided the input gathers have not been artificially flattened during post-processing.

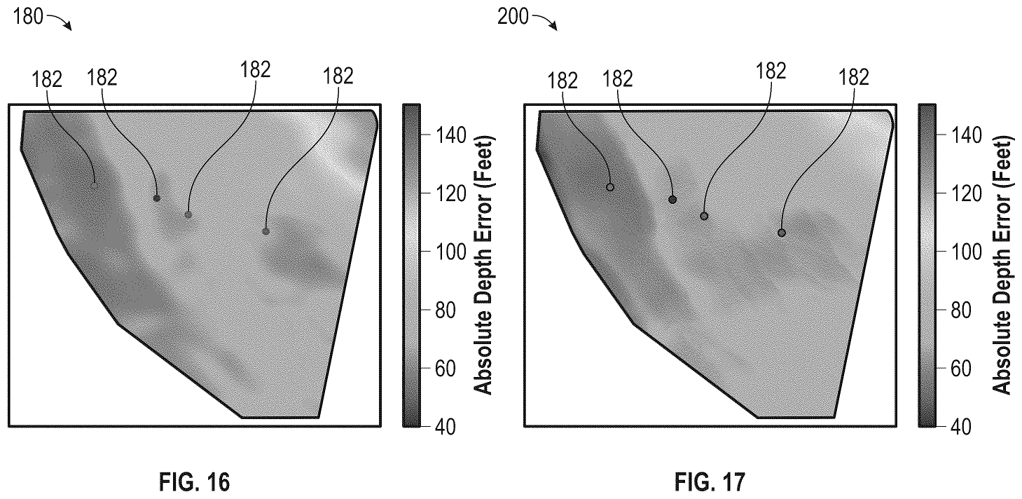

Referring now to FIGS. 16 and 17, FIG. 16 illustrates an exemplary depth uncertainty map 180 producible using the method 100 (e.g., using synthetic seismic gathers) shown in FIG. 6 while FIG. 17 illustrates a depth uncertainty map 200 producible using the method 150 (e.g., using true seismic gathers) shown in FIG. 15. Particularly, depth uncertainty maps 180 and 200 each indicate depth uncertainty estimated over a target surface from an offshore field using an ocean-bottom node dataset. Exemplary well misties 182 are identified in each depth uncertainty map 180 and 200. Additionally, each depth uncertainty map 180 and 200 illustrates the 90th percentile of depth prognoses from the population of perturbed velocity models that passed their respective predefined criterion (e.g., the threshold criterion for depth uncertainty map 180 and the semblance criterion for the depth uncertainty map 200).

In this example, at each CDP location, 6000 random perturbations were made to the velocity, anisotropy epsilon, and anisotropy delta components, with bounds of ±10%, ±50% and ±50%, respectively. Approximately 25% passed the predefined criterion and were used to define a distribution of depth prognoses. In this example, well misties 182 (which are not a fully independent measure, as they were indirectly used to inform the construction of the initial velocity model) generally coincide with the 67th-80th percentiles of the distribution of depth prognoses.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for estimating uncertainty in seismic-derived depth prognoses of a subsurface region, the method comprising:
(a) receiving an initial velocity model of a subsurface region based on seismic data associated with the subsurface region and captured by one or more seismic receivers;
(b) performing a seismic de-migration on initial post-migration seismic data obtained from the initial velocity model to obtain pre-migration seismic data;
(c) perturbing one or more components of the initial velocity model to produce a plurality of perturbed velocity models that are each different from the initial velocity model;
(d) performing a seismic migration of the pre-migration seismic data using the perturbed velocity model to obtain perturbed post-migration seismic data for each of the plurality of perturbed velocity models;
(e) estimating a depth error from a depth prognosis obtained from a selected subset of the perturbed velocity models based on characteristics of the perturbed post-migration seismic data migrated using the perturbed velocity models; and
(f) estimating a depth uncertainty from the estimated depth error.

2. The method of claim 1, wherein the pre-migration seismic data comprises one or more seismic gathers.

3. The method of claim 2, wherein the one or more seismic gathers comprise common image point seismic gathers.

4. The method of claim 2, wherein (b) further comprises generating a travel-time table from the initial velocity models using a vertically transverse isotropic (VTI) anisotropic processing model prior to performing the seismic de-migration.

5. The method of claim 4, wherein the seismic data comprises synthetic seismic gathers initially defined in a depth domain independent of the travel-time table.

6. The method of claim 5, wherein (d) comprises migrating one or more time-domain synthetic seismic gathers to the depth domain to obtain perturbed synthetic seismic gathers that comprise the perturbed post-migration seismic data.

7. The method of claim 1, wherein (f) comprises applying a predefined criterion to the plurality of perturbed velocity models to divide the plurality of perturbed velocity models between an acceptable group of perturbed velocity models used in estimating the depth uncertainty and an unacceptable group of perturbed velocity models not used in estimating the depth uncertainty.

8. The method of claim 1, wherein (f) comprises generating a distribution of the depth prognoses, and using a predefined percentile of the distribution of the depth prognoses to define the estimated depth uncertainty.

9. The method of claim 1, wherein the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.

10. A method for estimating uncertainty in seismic-derived depth prognoses of a subsurface region, the method comprising:
(a) receiving an initial velocity model of a subsurface region based on seismic data associated with the subsurface region and captured by one or more seismic receivers;
(b) performing a seismic de-migration on initial post-migration seismic data obtained from the initial velocity model to obtain pre-migration seismic data, wherein the initial post-migration seismic data comprises a plurality of initial seismic gathers obtained from the seismic data;
(c) perturbing the initial velocity model to produce a plurality of perturbed velocity models that are each different from the initial velocity model;
(d) performing a seismic migration of the pre-migration seismic data using the perturbed velocity model to obtain perturbed post-migration seismic data for each of the plurality of perturbed velocity models, wherein the perturbed post-migration seismic data comprises a perturbed seismic gather;
(e) determining a semblance for the perturbed seismic gather for each of the plurality of perturbed velocity models;
(f) selecting a subset of the plurality of perturbed velocity models by applying a predefined semblance criterion to the perturbed semblances to obtain one or more selected velocity models;
(g) estimating a depth error from a depth prognosis obtained from the one or more selected velocity models; and
(h) estimating a depth uncertainty from the estimated depth error.

11. The method of claim 10, wherein the initial post-migration seismic data comprises one or more seismic gathers obtained from the seismic data.

12. The method of claim 11, wherein the one or more seismic gathers comprise common image point gathers.

13. The method of claim 10, wherein the perturbed post-migration data comprises one or more perturbed seismic gathers and the perturbed semblance is obtained from the one or more perturbed seismic gathers.

14. The method of claim 10, wherein (f) comprises dividing the plurality of perturbed velocity models between an acceptable group of perturbed velocity models used in estimating the depth uncertainty, and an unacceptable group of perturbed velocity models not used in estimating the depth uncertainty.

15. The method of claim 10, wherein (h) comprises determining a distribution of the depth prognoses, and taking a predefined percentile of the distribution of the depth prognoses to define the estimated depth uncertainty.

16. The method of claim 10, wherein the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.

17. A system for estimating uncertainty of a seismic-derived depth prognoses of a subsurface region, the system comprising:
a processor;
a non-transitory memory; and
an application stored in the non-transitory memory that, when executed by the processor:
receives an initial velocity model of a subsurface region based on seismic data associated with the subsurface region and captured by one or more seismic receivers;
performs a seismic de-migration on initial post-migration seismic data obtained from the initial velocity model to obtain pre-migration seismic data;
perturbs one or more components of the initial velocity model to produce a plurality of perturbed velocity models that are each different from the initial velocity model;
performs a seismic migration of the pre-migration seismic data using the perturbed velocity model to obtain perturbed post-migration seismic data for each of the plurality of perturbed velocity models;
estimates a depth error from a depth prognosis obtained from a selected subset of the perturbed velocity models based on characteristics of the perturbed post-migration seismic data migrated using the perturbed velocity models; and
estimates a depth uncertainty from the estimated depth error.

18. The system of claim 17, wherein the application, when executed by the processor:
generates a distribution of the depth prognoses, and use a predefined percentile of the distribution of the depth prognoses to define the estimated depth uncertainty.

19. The system of claim 17, wherein the application, when executed by the processor:
applies a predefined criterion to the plurality of perturbed velocity models to divide the plurality of perturbed velocity models between an acceptable group of perturbed velocity models used in estimating the depth uncertainty and an unacceptable group of perturbed velocity models not used in estimating the depth uncertainty.

20. The system of claim 17, wherein the initial velocity model and each of the plurality of perturbed velocity models has at least one of a velocity component, an anisotropy epsilon component, and an anisotropy delta component that varies from the velocity component, the anisotropy epsilon component, and the anisotropy delta component of the initial velocity model.
